(19) United States
(12) Patent Application Publication
(10) Pub. No.: US 2025/0375900 A1
(43) Pub. Date: Dec. 11, 2025

(54) DOOR CLOSING SYSTEM OF AN ENERGY TRANSFER SYSTEM

(71) Applicant: Caterpillar Inc., Peoria, IL (US)

(72) Inventors: Matthew SHERWOOD, Christchurch (NZ); Elliot MOSS, Christchurch (NZ)

(73) Assignee: Caterpillar Inc.,, Peoria, IL (US)

(21) Appl. No.: 18/736,161

(22) Filed: Jun. 6, 2024

(51) Int. Cl. B25J 15/00; E05F 15/00

(52) U.S. Cl. CPC B25J 15/0019; E05F 15/00; E05Y 2900/518; E05Y 2900/534

(57) ABSTRACT

An energy transfer system includes a robotic system and a door closing system. The robotic system includes an end effector for enabling an energy transfer to a work machine via a receptacle access point of the work machine. The door closing system is mounted on the end effector of the robotic system. The door closing system is configured to close an access door of the receptacle access point. The door closing system includes an interaction system for interacting with the access door to allow the access door to close.

### TECHNICAL FIELD

The present disclosure relates generally to a door closing system and, for example, to a door closing system of an energy transfer system.

### BACKGROUND

Machines (e.g., that utilize an energy source other than fossil fuel, such as electricity, hydrogen, methanol, ammonia, or other sources of energy), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. In many cases, such a machine includes an energy transfer interface that can be physically connected to an energy transfer system to allow an energy transfer from the energy transfer system to an on-board energy storage system of the machine (e.g., to replenish the on-board energy storage system). The machine can include a door that, when in a closed position, protects or shields the energy transfer interface (e.g., from environmental conditions, such as when the machine is operating and moving for an intended purpose), and that, when in an open position, allows access to the energy transfer interface (e.g., to allow a connection to the energy transfer system).

In some cases, such as when the machine is a large work machine, the energy transfer interface and the door are positioned on the machine such that a human technician cannot practically reach the door in order to be able to interact with and close the door, such as after completion of an energy transfer operation. For example, the door can be designed to swing vertically upward (e.g., on a hinge) to an open position, such that the door is then positioned at a height that is too high for a human technician to physically reach (e.g., without use of a ladder or a tool) to close the door. At a work site with non-uniform, changing terrain (e.g., a work site associated with an industry, such as mining or construction), setting up a ladder, staircase, or scaffolding, is often not possible or not feasible. Further, using another machine, such as an elevating work platform, to enable the human technician to be lifted to access the door creates other challenges (e.g., due to the complexity involved in using the other machine), such as increased time requirements for setup and maneuvering of the other machine and the potential risk of the other machine colliding with and damaging the machine.

China Patent Publication No. CN219077050U (“the '050 publication”) discloses an intelligent charging system, which is provided with a charging system rack and further comprises an image recognizer, a controller, a cooperative mechanical arm assembly and a visual system, and the image recognizer, the cooperative mechanical arm assembly and the visual system are respectively in communication connection with the controller. In the '050 publication, the image recognizer can recognize vehicle information and transmit the recognized information to the controller, the visual system recognizes the position of a vehicle charging port and transmits the information to the controller, and the controller controls the cooperative mechanical arm to act to open or close a charging port cover of a vehicle and conduct charging.

Further, per the '050 publication, a charging port cover end device is mounted on a first robot arm, and the charging port cover end device includes a charging port outer cover opening and closing assembly and a charging port inner cover opening and closing assembly, for example, a suction cup assembly including opening/closing of the charging port cover, to effect opening or closing of the charging port outer cover. The controller drives the first mechanical arm and the pneumatic system, the clamping cylinder drives the soft claw to clamp the inner cover, and the inner cover is pulled out, so that the charging opening inner cover is closed and opened. The charging port outer cover opening and closing assembly comprises a sucker, a pressure switch and a vacuum pump, the controller controls the vacuum pump to vacuumize, and the pressure switch controls the sucker to suck or loosen the charging port outer cover.

While the cooperative mechanical arm assembly, per the '050 publication, is able to close a charging port cover, the mechanical arm assembly is complex. Such complexity introduces multiple points of failure, which can lead to system malfunctions and downtime. Any malfunction of the system can potentially cause contact damage to the vehicle and the vehicle charging port. Additionally, environmental conditions (e.g., that include rain, snow, dirt, debris, among other examples) could impact a reliability and performance of the mechanical arm assembly. For example, water or dirt accumulation on a charging port cover can affect a performance of the soft claw and the sucker, which can result in the mechanical arm being unable to close the charging port cover.

The door closing system of the present disclosure solves one or more of the problems set forth above and/or other problems in the art.

### SUMMARY

In some implementations, a robotic system comprises an end effector for enabling an energy transfer to a work machine via a receptacle access point of the work machine, wherein the end effector is configured to close an access door of the receptacle access point.

In some implementations, an end effector of a robotic system includes a door closing system for closing an access door of a receptacle access point, wherein the door closing system includes an interaction system for interacting with the access door to allow the access door to close.

In some implementations, a door closing system of an end effector of a robotic system includes an interaction system, for interacting with and closing an access door of a receptacle access point, that includes a door interaction component; and a driver component.

### BRIEF DESCRIPTION OF THE DRAWINGS

FIG. 1 is a diagram of an example work machine described herein.

FIGS. 2A-2B are diagrams of examples of a receptacle access point described herein.

FIGS. 3A-3B are diagrams of an example energy transfer system described herein.

FIGS. 4A-4B are diagrams of examples of the end effector of a robotic system of the energy transfer system described herein.

FIGS. 5A-5D are diagrams of example configurations of a door closing system of the energy transfer system described herein.

FIG. 6 is a diagram of example components of the door closing system of an energy transfer system.

FIG. 7 is a flowchart of an example process associated with a door closing system of an energy transfer system.

### DETAILED DESCRIPTION

This disclosure relates to a door closing system of an energy transfer system that is configured to enable an energy transfer to a work machine, which is applicable to any work machine that is at least partially powered by a non-fossil-fuel-based energy storage system. The work machine may be any type of machine configured to perform operations associated with an industry such as mining, construction, farming, transportation, or any other industry.

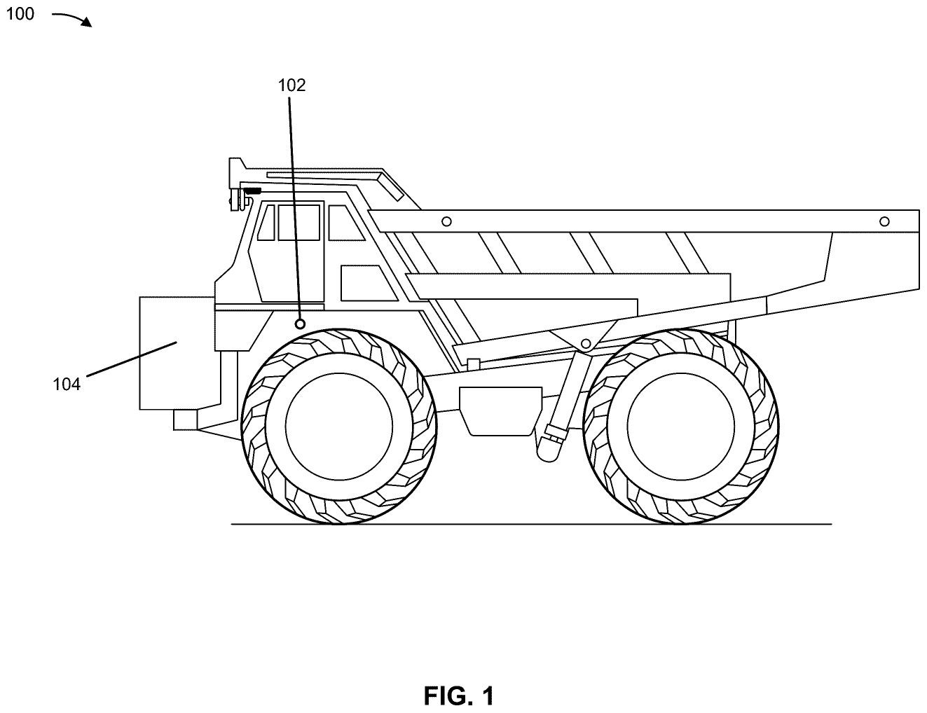

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system 102 (e.g., included within a chassis of the work machine 100) and a receptacle access point 104.

The work machine 100 may be configured to be at least partially powered by the energy storage system 102. That is, the work machine may be a machine that utilizes electricity, hydrogen, methanol, ammonia, or other sources of energy other than a fossil fuel. As a specific example, when the energy storage system 102 includes a battery that stores electricity, the work machine 100 may be a battery electric machine (BEM), a battery electric vehicle (BEV), a hybrid vehicle, a fuel cell and battery hybrid vehicle, or another machine that is at least partially powered by the battery of the energy storage system 102. The work machine 100 may include one or more engines, one or more motors, one or more conversion systems, and/or other components that are configured to convert and/or use energy stored in the energy storage system 102, to cause overall movement of the work machine 100 across a work site and/or to cause movement of individual components or systems of the work machine 100.

The receptacle access point 104 provides an energy transfer interface (e.g., a physical energy transfer interface) for the energy storage system 102. For example, the receptacle access point 104 provides an energy transfer interface that can be physically connected to an energy transfer system (e.g., the energy transfer system 300 described herein) to allow an energy transfer from the energy transfer system to the energy storage system 102 (or vice versa). The receptacle access point 104 may be located on a front of the work machine 100 (as shown), a side of the work machine 100, a back of the work machine 100, a bottom of the work machine 100, a top of the work machine 100, or at any other position on the work machine 100. The receptacle access point 104 is further described herein.

As indicated above, FIG. 1 is provided as an example. Other examples may differ from what is described in connection with FIG. 1.

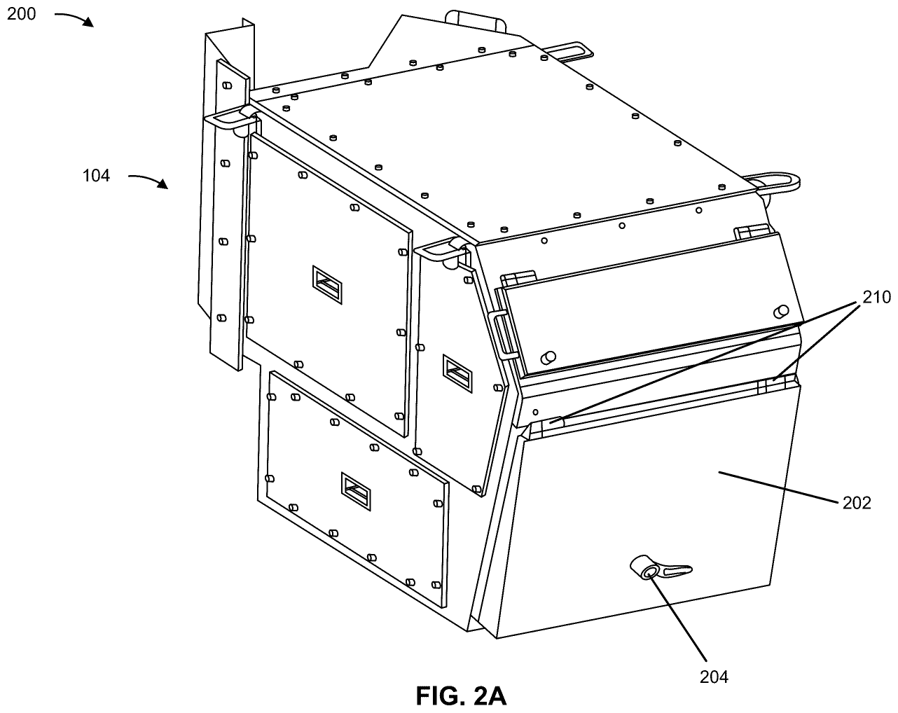

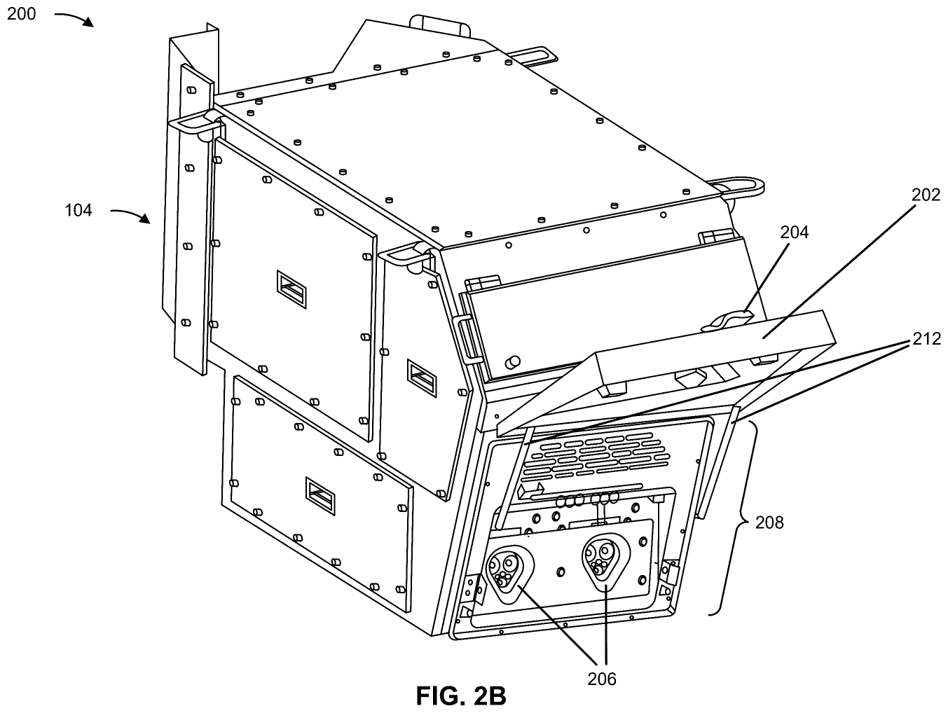

FIGS. 2A-2B are diagrams (e.g., front-angled views) of examples 200 of the receptacle access point 104 described herein. As shown in FIGS. 2A-2B, the receptacle access point 104 includes an access door 202, an access mechanism 204, and one or more receptacles 206. FIG. 2A shows the receptacle access point 104 in a closed state (e.g., when the access door 202 is in a closed position), and FIG. 2B shows the receptacle access point 104 in an open state (e.g., when the access door 202 is in an open position).

The access door 202 comprises a metal, or other hard and/or weather resistant material, and is configured to protect internal components of the receptacle access point 104, such as an interior panel 208 of the receptacle access point 104, when in the closed position. For example, when the access door 202 is in the closed position (e.g., such that edges of the access door 202 cover a flange of the interior panel 208) the access door 202 may prevent dirt, rocks, construction debris, waste matter, moisture, or other material (e.g., present at a work site at which the work machine 100 is operating) from accessing the interior panel 208. The access door 202 is moveable. For example, the access door 202 may be moved from the closed position (e.g., shown in FIG. 2A) to the open position (e.g., shown in FIG. 2B), such as by causing the access door 202 to pivot on one or more hinges 210. The receptacle access point 104 may include one or more support components 212 (e.g., one or more stays, one or more pistons, and/or one or more pneumatic cylinders, among other examples) that facilitate opening of the access door 202 (e.g., that facilitate movement of the access door 202 from the closed position to the open position) and/or that facilitate the access door 202 remaining in the open position (e.g., by resisting any force exerted on the access door 202 that is less than a force threshold that is associated with closing the access door 202, as further described herein).

The access mechanism 204 may be located on the access door 202, as shown in FIGS. 2A-2B, or may be located at any other position on the receptacle access point 104. The access mechanism 204 is configured to allow the access door 202 to open (e.g., to allow the access door 202 to move from the closed position to the open position and/or to remain at the open position) when the access mechanism 204 is disengaged. Further, the access mechanism 204 is configured to allow the access door 202 to remain closed (e.g., to remain in the closed position) when the access mechanism is engaged (e.g., after the access door 202 is moved to the closed position). That is, the access mechanism 204 may “lock” the access door 202 in the closed position when engaged, and may “unlock” the access door 202 to allow the access door 202 to move to the open position when disengaged.

The access mechanism 204 is configured to be manipulatable to cause the access mechanism 204 to be engaged (e.g., to change from disengaged to engaged) or to be disengaged (e.g., to change from engaged to disengaged). For example, the access mechanism 204 may be configured to be rotated, slid, pushed, pulled, lifted, extended, and/or retracted, among other examples, to cause the access mechanism 204 to be engaged or disengaged. Accordingly, the access mechanism 204 may include a latch, a bolt, a catch, a hook, a hasp, and/or a fastener, among other examples. The access mechanism 204 may include a portion, such as a latch portion, upon which a force can be applied to cause the access mechanism 204 to disengage (or, alternatively, to engage). In some implementations, the access mechanism 204 may be configured to automatically engage when the access door 202 is moved to the closed position (e.g., from the open position or from any other non-closed position). In this way, the access mechanism may “automatically lock” the access door 202 in the closed position.

As shown in FIG. 2B, the one or more receptacles 206 may be included on the interior panel 208 of the receptacle access point 104. Each of the one or more receptacles 206 may be any type of physical component for coupling with a plug of an energy transfer system (e.g., a plug 402 of the energy transfer system 300 described herein) to enable an energy transfer from the energy transfer device to the energy storage system 102 (or vice versa). While the term “receptacles” is used herein, the one or more receptacles 206 may include plugs, ports, connectors, or any other type of physical energy transfer component.

As indicated above, FIGS. 2A-2B are provided as an example. Other examples may differ from what is described in connection with FIGS. 2A-2B.

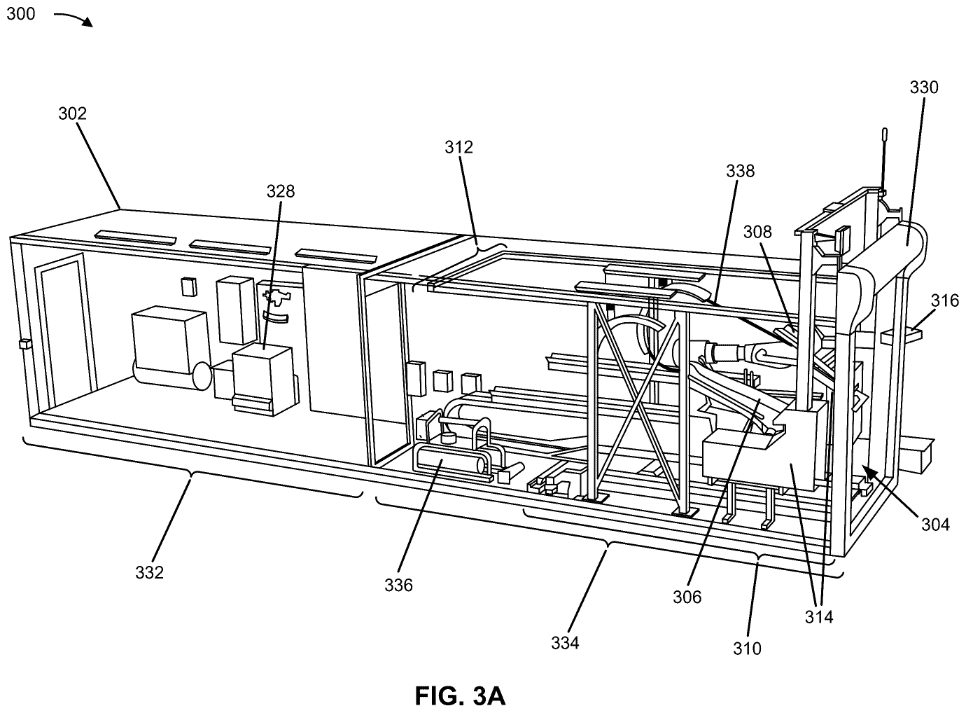

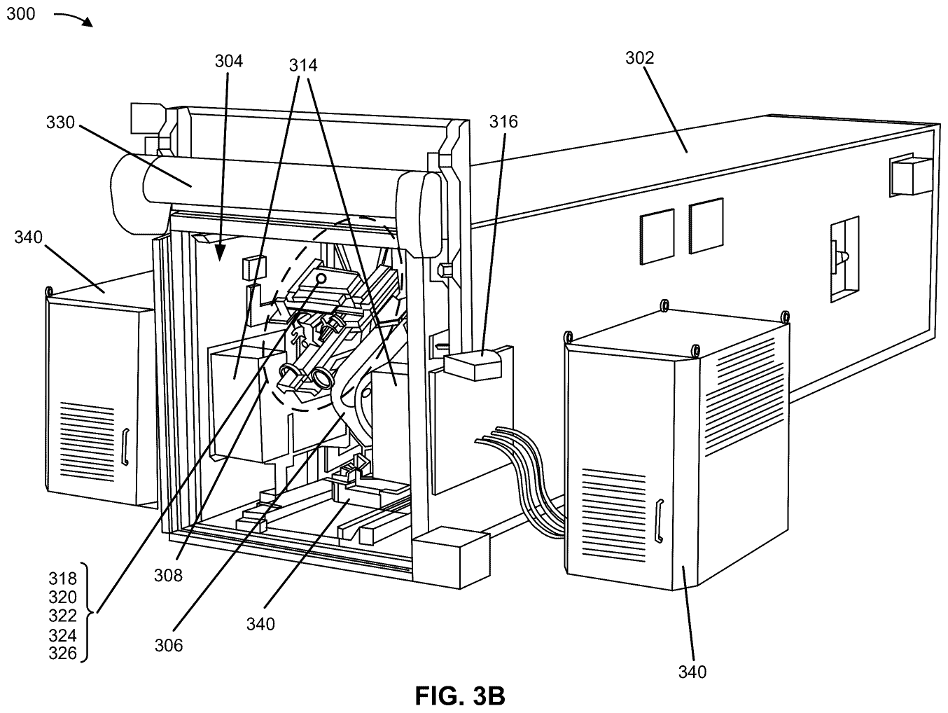

FIGS. 3A-3B are diagrams of an example energy transfer system 300. The energy transfer system 300 is configured to enable an energy transfer to and/or from the work machine 100 (e.g., to and/or from the energy storage system 102 of the work machine 100). In some implementations, the energy transfer system 300 is configured to autonomously enable the energy transfer (e.g., as further described herein), such as without any interaction with a human technician. However, other implementations include a human technician interacting with the energy transfer system 300 and, thus, the term “energy transfer system” includes any energy transfer system that is not autonomous, that is semi-autonomous (e.g., includes at least one autonomously controlled or operated system or component), or that is fully autonomous. FIG. 3A shows a side (cut-away) view of the energy transfer system 300, and FIG. 3B shows a front-angled view of the energy transfer system 300.

As shown in FIGS. 3A-3B, the energy transfer system 300 may include a housing 302 that includes a portal 304 at an end of the housing; a robotic system 306 that includes an end effector 308; a slide system 310; a cable management system 312; an energy transfer outlet system 314; a first camera system 316; a second camera system 318; a door opening system 320; a connector retention system 322; a connector protection system 324; a door closing system 326; and/or one or more controllers 328.

The housing 302 comprises a metal, or other hard and/or weather resistant material, and may have a rectangular prism shape. For example, the housing 302 may have a similar size and/or dimensions of a shipping container (e.g., with four “long” sides and two “short” sides). The housing 302 may include the portal 304 at an end of the housing 302 (e.g., instead of one of the short sides of the housing 302). The energy transfer system 300 may include an access door 330 that is configured to cover the portal 304 when closed, and to uncover the portal 304 when open. For example, the access door 330 may be a retractable door. The access door 330, when closed, may protect an interior of the housing 302, such by preventing dirt, rocks, construction debris, waste matter, moisture, or other material (e.g., present at a work site at which the work machine 100 is operating) from accessing interior of the housing 302.

As shown in FIG. 3A, the interior of the housing 302 may be divided into a first interior portion 332 of the housing 302 and a second interior portion 334 of the housing 302 (e.g., that is separated by a wall, a door, or another separator). The first interior portion 332 of the housing 302 may include the one or more controllers 328 and/or one or more other electrical components, one or more pneumatic components, and/or one or more other communication components, among other examples, that enable operation of the systems and components included in the second interior portion 334 of the housing 302.

The second interior portion 334 of the housing 302 may include the slide system 310, the cable management system 312, and the energy transfer outlet system 314. The second interior portion 334 may also include additional systems and/or components for enabling operation of the robotic system 306 and/or an energy transfer operation, such as a pressure washer system 336 and one or more energy transfer cables 338 (e.g., that are configured to transmit energy to and/or from one or more plugs of the end effector 308, such as the one or more plugs 402 described herein).

The slide system 310 is configured to move the robotic system 306, via the portal 304 of the housing 302, between an interior of the housing 302 (e.g., the second interior portion 334 of the housing 302) and an external environment (e.g., that surrounds the housing 302, such as at a work site). The cable management system 312 is configured to provide management of the one or more energy transfer cables 338. The energy transfer outlet system 314 is configured to enable a connection between the one or more energy transfer cables 338 and an external transfer dispenser system 340 (e.g., that is not included in the energy transfer system 300). Accordingly, the external transfer dispenser system 340 may provide energy to the one or more energy transfer cables 338, and thus to plugs of the end effector (e.g., the plugs 402 described herein) via the energy transfer outlet system 314.

As shown in FIGS. 3A-3B, the first camera system 316 may be mounted on an exterior (e.g., an exterior side) of the housing 302. The first camera system 316 is configured to obtain first image data associated with the receptacle access point 104 (e.g., when mounted on the work machine 100). For example, the first camera system 316 may obtain the first image data to allow the one or more controllers 328 to determine whether the receptacle access point 104 is within an engagement range of the robotic system 306 (e.g., when the robotic system 306 is moved to the external environment by the slide system 310), such as to allow the robotic system 306 to interact with the receptacle access point 104 to initiate an energy transfer operation.

As shown in FIG. 3A, the second interior portion 334 of the housing 302 may include the robotic system 306 (e.g., mounted to the slide system 310), such as when the robotic system 306 has been moved to the interior of the housing 302 by the slide system 310. The robotic system 306 is configured to enable an energy transfer to or from the work machine 100 (e.g., to or from the energy storage system 102 of the work machine 100), such as when the robotic system 306 has been moved to the external environment by the slide system 310.

In some implementations, the robotic system 306 is configured to close the access door 202 of the receptacle access point 104 (e.g., after cessation of an energy transfer operation enabled by coupling of the one or more receptacles 206 to one or more plugs of the end effector 308). For example, the robotic system 306 may be configured to contact the access door 202, to move along a path, and to apply a force on the access door 202 while moving along the path to allow the access door 202 to close. As another example, the robotic system 306 may be configured to contact a control element (e.g., a button, a switch, an actuator, or another type of control element) of the work machine 100 to cause the access door 202 to close (e.g., the robotic system 306 contacting the control element causes the work machine 100 to actuate closing of the access door 202). In an additional example, the robotic system 306 may be configured to send a signal (e.g., wirelessly, such as via a radio frequency (RF) communication) to the work machine 100 to cause the access door 202 to close (e.g., the robotic system 306 sending the signal causes the work machine 100 to actuate closing of the access door 202).

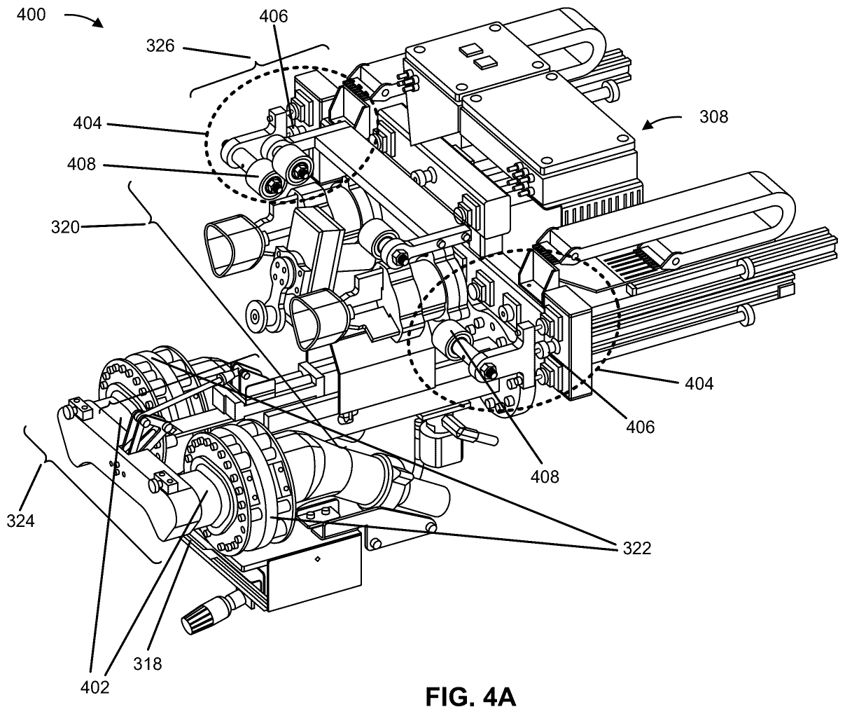

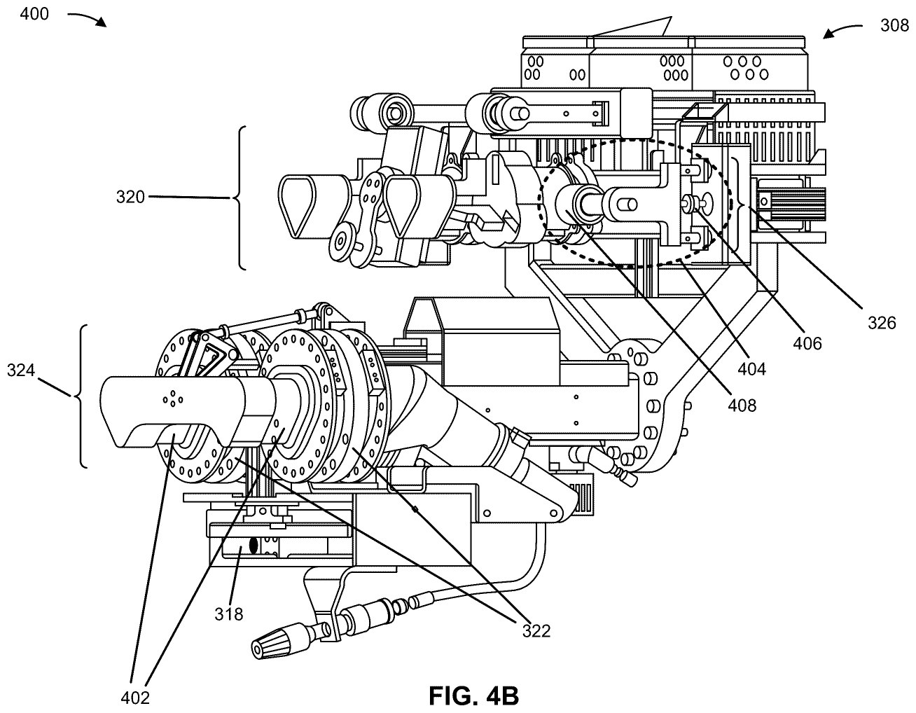

Further, the robotic system includes the end effector 308, which may include (e.g., mounted to the end effector 308) the second camera system 318, the door opening system 320, the connector retention system 322, the connector protection system 324, and/or the door closing system 326. As the illustration of the end effector 308 is too small in FIGS. 3A-3B to clearly depict the second camera system 318, the door opening system 320, the connector retention system 322, the connector protection system 324, and/or the door closing system 326, these systems and the end effector 308 are shown in greater detail in FIGS. 4A-4B.

The second camera system 318 is configured to obtain second image data associated with the access mechanism 204 of the receptacle access point 104. For example, the second camera system 318 may obtain the second image data to allow the one or more controllers 328 to identify a location of the access mechanism 204 of the receptacle access point 104, such as to allow the door opening system 320 to open the access door 202 of the receptacle access point 104 (e.g., as further described herein). Further, the second camera system 318 is configured to obtain third image data associated with the one or more receptacles 206 included in the receptacle access point 104. For example, the second camera system 318 may obtain the third image data to allow the one or more controllers 328 to identify a location of the one or more receptacles 206, such as to enable one or more plugs of the end effector 308 (e.g., the one or more plugs 402 of the end effector 308 further described herein) to couple to the one or more receptacles 206 (e.g., as further described herein) and thereby enable the energy transfer operation.

The door opening system 320 is configured to open the access door 202 of the receptacle access point 104 (e.g., based on the location of the access mechanism 204 of the receptacle access point 104 identified by the one or more controllers 328). The connector retention system 322 is configured to enable coupling between the one or more plugs of the end effector 308 (e.g., the one or more plugs 402 of the end effector 308 further described herein) and the one or more receptacles 206 (e.g., to enable the energy transfer operation). The connector protection system 324 is configured to protect the one or more plugs of the end effector 308 (e.g., the one or more plugs 402 of the end effector 308 further described herein) when not coupled to the one or more receptacles 206.

The door closing system 326 is configured to close the access door 202 of the receptacle access point 104 (e.g., after cessation of an energy transfer operation enabled by coupling of the one or more receptacles 206 to one or more plugs of the end effector 308). The door closing system 326 may include an interaction system (e.g., the interaction system 404 described herein in relation to FIGS. 4A-4B) for interacting with the access door 202 to allow the access door 202 to close.

As indicated above, FIGS. 3A-3B are provided as an example. Other examples may differ from what is described in connection with FIGS. 3A-3B.

FIGS. 4A-4B are diagrams of examples 400 of the end effector 308 of the robotic system 306 described herein. FIG. 4A shows a side-angled view of the end effector 308, and FIG. 4B shows a front-angled view of the end effector 308.

As shown in FIGS. 4A-4B, the end effector 308 includes one or more plugs 402. Each of the one or more plugs 402 may be any type of physical component for coupling with a corresponding receptacle 206 of the receptacle access point 104 to enable an energy transfer from the energy transfer system 300 to the work machine 100 (e.g., to the energy storage system 102 of the work machine 100) (or vice versa). While the term “plugs” is used herein, the one or more plugs 402 may include receptacles, ports, connectors, or any other type of physical energy transfer component.

As further shown in FIGS. 4A-4B, the end effector 308 may include (e.g., mounted to the end effector 308) the second camera system 318, the door opening system 320, the connector retention system 322, the connector protection system 324, and/or the door closing system 326. For example, as shown in FIGS. 4A-4B, the second camera system 318 may be positioned at a bottom of the end effector 308, the one or more plugs 402 may be positioned above the second camera system 318 (and the connector retention system 322 and the connector protection system 324 may be positioned in line with the one or more plugs 402), the door opening system 320 may be positioned above the one or more plugs 402, and the door opening system 320 may be positioned above the door closing system 326. While FIGS. 4A-4B show one possible configuration, some other configurations include the second camera system 318, the door opening system 320, the connector retention system 322, the connector protection system 324, and/or the door closing system 326 in different positions.

The door closing system 326 may include an interaction system 404 for interacting with the access door 202 to allow the access door 202 to close (e.g., when the receptacle access point 104 is within an engagement range of the robotic system 306). The interaction system 404 may be configured to contact the access door 202 (e.g., when the access door 202 is in an open position) and to apply a force (e.g., a pushing force) on the access door 202 to allow the access door 202 to close. The applied force may be greater than or equal to a force threshold associated with closing the access door 202, such that the access door 202 is able to move to the closed position (e.g., by overcoming a resistive force of the one or more support components 212). The access door 202 may then be locked in the closed position upon engagement of the access mechanism 204 of the receptacle access point 104.

In some implementations, the interaction system 404 may include a driver component 406 and a door interaction component 408. The driver component 406 is configured to cause the door interaction component 408 to move (e.g., to contact the access door 202 of the receptacle access point 104, as described herein). The driver component 406 may include, for example, a pneumatic cylinder, or another type of component that is configured to drive movement of the door interaction component 408.

The door interaction component 408 (e.g., when driven by the driver component 406) is configured to contact the access door 202, to move along a path (e.g., from an initial point of the path to a termination point of the path), and to apply a force on the access door 202 while moving along the path to allow the access door 202 to close. To move along the path and to apply the force on the access door 202 (e.g., concurrently), the door interaction component 408 may be configured to contact and roll along a region of the access door 202 (e.g., a region of an outside surface of the access door 202). Accordingly, the door interaction component 408 may include one or more rollers (e.g., as shown in FIGS. 4A-4B), or other components that are able to roll along the region.

When the applied force is greater than or equal to the force threshold (e.g., when the applied force is great enough to overcome the resistive force of the one or more support components 212), the door interaction component 408 may move the access door 202 to the closed position. The access door 202 then may be “locked” in the closed position upon engagement of the access mechanism 204 of the receptacle access point 104, which may occur as a result of moving the access door 202 to the closed position (e.g., when the access mechanism 204 is configured to automatically engage upon the access door 202 moving to the closed position).

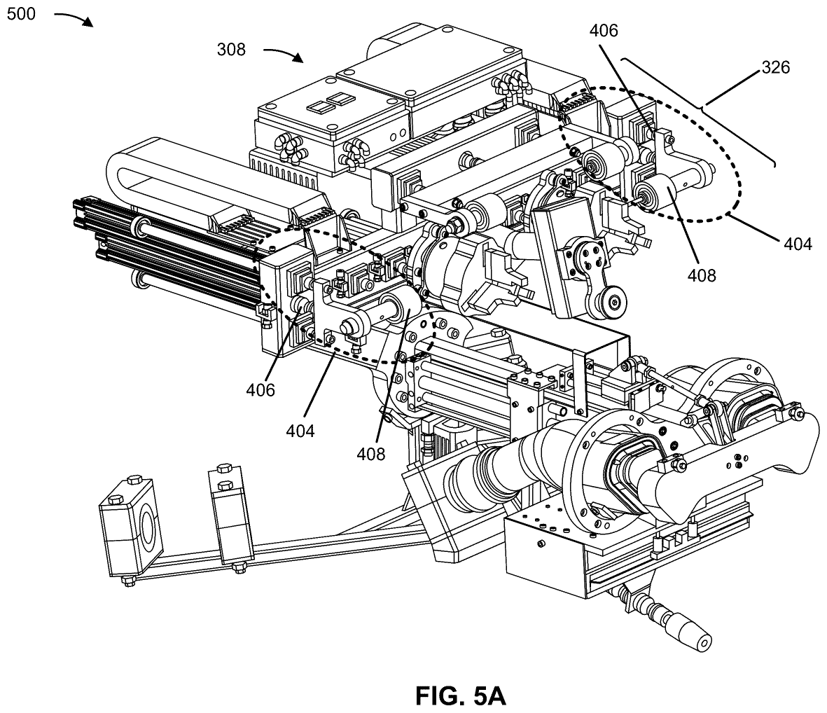

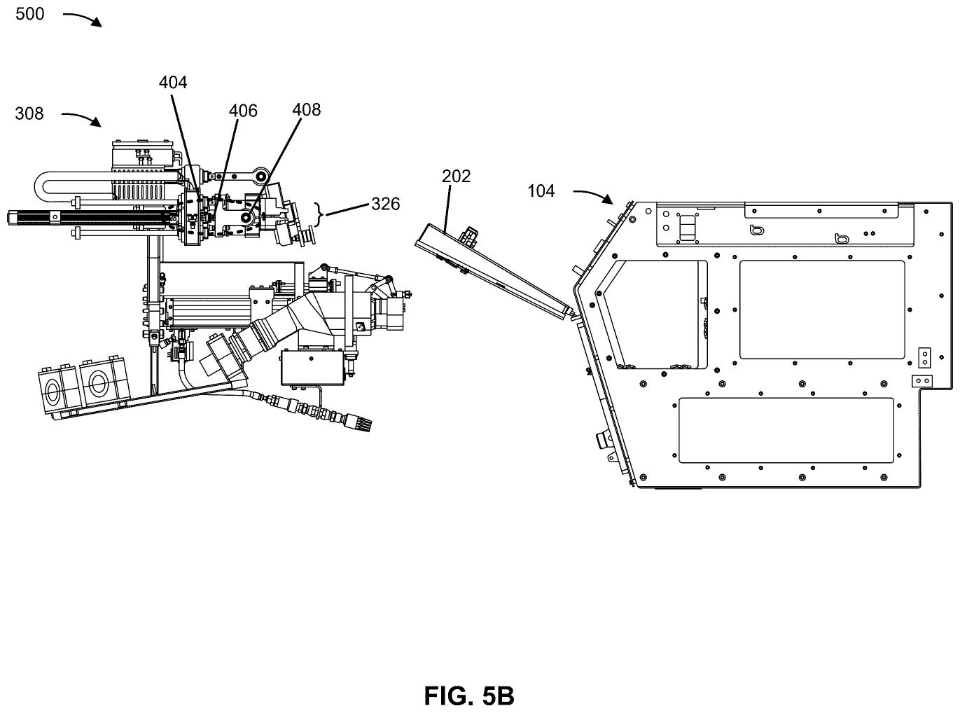

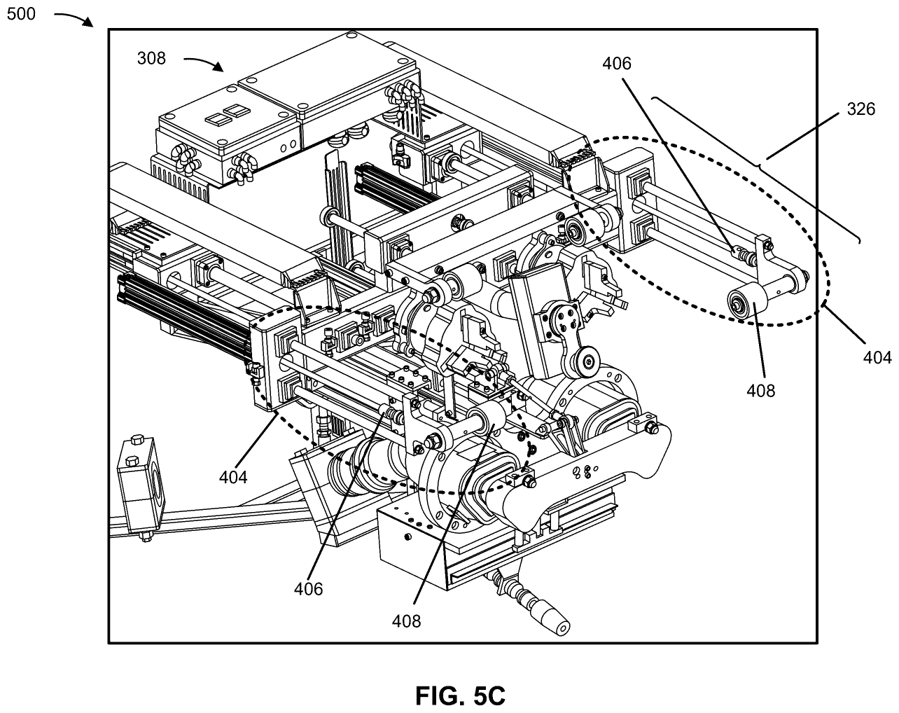

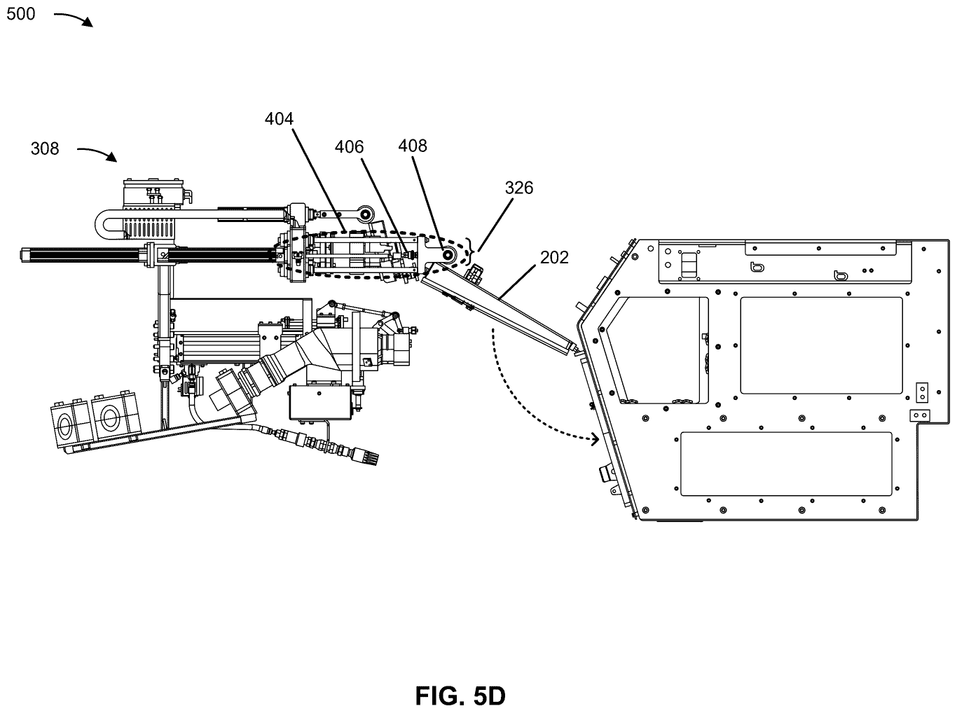

Further details related to the interaction system 404, the driver component 406, and the door interaction component 408 are described herein in relation to FIGS. 5A-5D.

As indicated above, FIGS. 4A-4B are provided as an example. Other examples may differ from what is described in connection with FIGS. 4A-4B.

FIGS. 5A-5D are diagrams of example configurations 500 of the door closing system 326. FIGS. 5A-5B show a front-angled view and a side view, respectively, of the door closing system 326 in a first configuration (e.g., when the door closing system 326 is not performing a door closing operation). As shown in FIGS. 5A-5B, the interaction system 404 may be in a non-operational state. Accordingly, the door interaction component 408 is retracted, such as to a maximum retraction position. The driver component 406 may be configured to cause the door interaction component to be retracted when the interaction system 404 is in the non-operational state.

FIGS. 5C-5D show a front-angled view and a side view, respectively, of the door closing system 326 in a second configuration (e.g., when the door closing system 326 is initiating a door closing operation). As shown in FIG. 5B, the interaction system 404 may be in an operational state (e.g., to allow the door interaction component to contact the access door 202 of the receptacle access point 104). Accordingly, the door interaction component 408 is extended, such as to a maximum extension position. The driver component 406 may be configured to cause the door interaction component to be extended when the interaction system 404 is in the operational state to thereby allow the door interaction component to contact the access door 202.

As shown in FIG. 5B, the door closing system 326 may be in the first configuration prior to performing a door closing operation to close the access door 202 of the receptacle access point 104 (e.g., after cessation of an energy transfer). As shown in FIG. 5D, as part of initiating the door closing operation, the door closing system 326 may be in the second configuration. For example, as shown in FIG. 5D, the door interaction component 408 may contact an outer surface of the access door 202. Thereafter, as part of performing the door closing operation, the door interaction component 408 may move along a path (e.g., an arc-shaped path when the access door 202 is configured to pivot on the one or more hinges 210), such as based on a movement of the end effector 308 of the robotic system 306 (e.g., the end effector 308 may tilt, and/or otherwise move, to cause the door interaction component 408 to move). The door interaction component may therefore move from an initial point of the path (e.g., shown in FIG. 5D) to a termination point of the path. Accordingly, the door interaction component 408 may apply a force (e.g., as a result of moving along the path) to allow the access door 202 to close (e.g., to allow the access door 202 to move to the closed position, shown in FIG. 2A, and remain in the closed position, such as when the access mechanism 204 locks the access door 202 in the closed position).

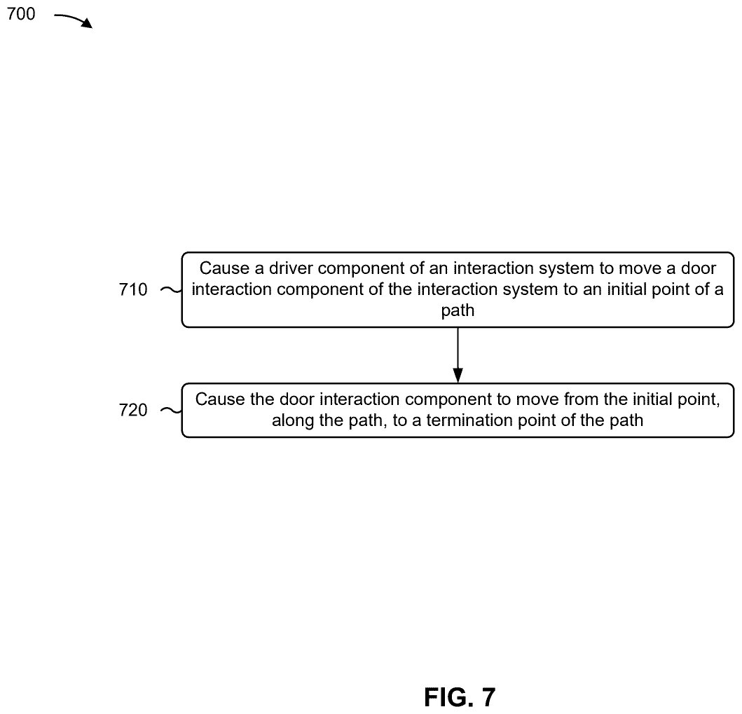

The one or more controllers 328 may control the end effector 308 and/or the driver component 406 of the interaction system 404 to cause the door interaction component 408 to move, as further described herein in relation to FIG. 7.

As indicated above, FIGS. 5A-5D are provided as an example. Other examples may differ from what is described in connection with FIGS. 5A-5D.

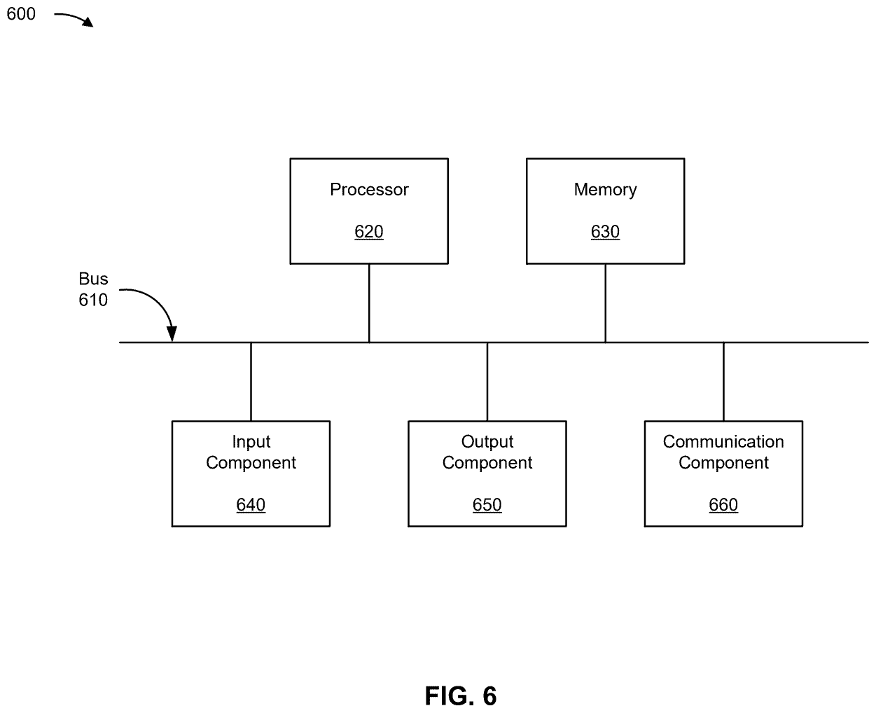

FIG. 6 is a diagram of example components of a device 600 associated with a door closing system of an energy transfer system. The device 600 may correspond to the one or more controllers 328 and/or one or more other components of the energy transfer system 300. The one or more controllers 328 and/or one or more other components of the energy transfer system 300 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. The processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. The memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. Execution of the set of instructions, by one or more processors 620, causes the one or more processors 620 and/or the device 600 to perform one or more operations or processes described herein. Hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

FIG. 7 is a flowchart of an example process 700 associated with a door closing system (e.g., the door closing system 326) of an energy transfer system (e.g., the energy transfer system 300). The door closing system may include an interaction system (e.g., the interaction system 404) that includes a driver component (e.g., the driver component 406) and a door interaction component (e.g., the door interaction component 408). One or more process blocks of FIG. 7 may be performed by one or more controllers (e.g., the one or more controllers 328) of the energy transfer system. One or more process blocks of FIG. 7 may be performed by another device or a group of devices separate from or including the one or more controllers, such as one or more other components of the energy transfer system. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include causing the driver component of the interaction system to move the door interaction component of the interaction system to an initial point of a path (block 710). For example, the one or more controllers may cause the driver component of the interaction system to move the door interaction component of the interaction system to an initial point of a path. The door interaction component is to contact an access door (e.g., the access door 202 of the receptacle access point 104) when moved to the initial point of the path.

As further shown in FIG. 7, process 700 may include causing the door interaction component to move from the initial point, along the path, to a termination point of the path (block 720). For example, the one or more controllers may cause the door interaction component to move from the initial point, along the path, to a termination point of the path, such as by controlling movement of an end effector (the end effector 308) of a robotic system (e.g., the robotic system 306) of the energy transfer system. The door interaction component is to roll along a region of the access door when moved along the path to the termination point.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

### INDUSTRIAL APPLICABILITY

The disclosed door closing system is used to close an access door of a receptacle access point of a work machine. Thus, the door closing system eliminates a need for a human technician to interact with the access door in order to close the access door. For example, the door closing system includes an interaction system for interacting with the access door to allow the access door to close. The interaction system is configured to contact the access door when the access door is in an open position and to apply a force on the access door to allow the access door to close. The interaction system includes a door interaction component that is configured to contact the access door, to move along a path, and to apply a force on the access door while moving along the path to allow the access door to close. For example, the door interaction component is configured to contact and roll along a region of the access door. Accordingly, the force applied by the door interaction component is great enough to overcome a resistive force of one or more support components of the access door, and the door interaction component thereby causes the access door to move to the closed position.

In this way, the door closing system enables automatic closing of an access door of a receptacle access point of a work machine. Accordingly, when the access door is in an unreachable open position (e.g., at a height that is too high for a human technician to reach), other tools or mechanisms (e.g., ladders, staircases, scaffolding, elevating work platforms, among other examples) are not needed to assist (e.g., the human technician) in reaching the access door. Therefore, no extra time is required to setup and maneuver another machine to facilitate closing the door, and a potential risk of damaging the work machine by operating the other machine is eliminated. Further, because the door closing system is part of an energy transfer system that facilitates an energy transfer to (or from) the work machine, the door closing system is able to close the access door after completion of the energy transfer, regardless of the terrain and environmental conditions at the work site (which would not otherwise be possible when a human technician is needed to the close the access door at a work site with particular inhospitable conditions).

What is claimed is:

1. A robotic system comprising:
an end effector for enabling an energy transfer to a work machine via a receptacle access point of the work machine,
wherein the robotic system is configured to close an access door of the receptacle access point.

2. The robotic system of claim 1, wherein the robotic system is configured to contact the access door, to move along a path, and to apply a force on the access door while moving along the path to allow the access door to close.

3. The robotic system of claim 1, wherein the robotic system is configured to contact a control element of the work machine to cause the access door to close.

4. The robotic system of claim 1, wherein the robotic system is configured to send a signal to the work machine to cause the access door to close.

5. The robotic system of claim 1 further comprising:
a door closing system mounted on the end effector of the robotic system, wherein:
the door closing system includes an interaction system for interacting with the access door to allow the access door to close.

6. The robotic system of claim 5, wherein:
the interaction system is configured to contact the access door when the access door is in an open position and to apply a force on the access door to allow the access door to close.

7. The robotic system of claim 5, wherein:
the interaction system includes a door interaction component that is configured to contact the access door, to move along a path, and to apply a force on the access door while moving along the path to allow the access door to close.

8. The robotic system of claim 7, wherein:
the door interaction component is further configured to move along the path and to apply the force on the access door while moving along the path, to contact and roll along a region of the access door.

9. The robotic system of claim 7, wherein:
the interaction system further includes a driver component that is configured to cause the door interaction component to move to an initial point of the path.

10. The robotic system of claim 5, further comprising one or more controllers configured to:
cause a driver component of the interaction system to move a door interaction component of the interaction system to an initial point of a path,
wherein the door interaction component is to contact the access door when moved to the initial point of the path; and
cause the door interaction component to move from the initial point, along the path, to a termination point of the path,
wherein the door interaction component is to roll along a region of the access door when moved along the path to the termination point.

11. An end effector of a robotic system, comprising:
a door closing system for closing an access door of a receptacle access point, wherein the door closing system includes:
an interaction system for interacting with the access door to allow the access door to close.

12. The end effector of the robotic system of claim 11, wherein:
the interaction system is configured to contact the access door and to apply a force on the access door to allow the access door to close.

13. The end effector of the robotic system of claim 11, wherein:
the interaction system includes a door interaction component that is configured to move along a path and to apply a force on the access door while moving along the path to allow the access door to close.

14. The end effector of the robotic system of claim 11, wherein:
the interaction system includes a door interaction component that is configured to contact and roll along a region of the access door to allow the access door to close.

15. The end effector of the robotic system of claim 11, wherein:
the interaction system includes a driver component that is configured to cause a door interaction component of the interaction system to move to an initial point of a path and to apply a force on the access door while moving along the path to allow the access door to close.

16. The end effector of the robotic system of claim 11, wherein:
the interaction system includes a driver component that is configured to cause a door interaction component of the interaction system to contact and roll along a region of the access door to allow the access door to close.

17. A door closing system of an end effector of a robotic system, comprising:
an interaction system, for interacting with and closing an access door of a receptacle access point, that includes:
a door interaction component; and
a driver component.

18. The door closing system of claim 17, wherein:
the door interaction component is configured to move and to apply a force on the access door while moving.

19. The door closing system of claim 17, wherein:
the door interaction component is configured to contact and roll along a region of the access door.

20. The door closing system of claim 17, wherein:
the driver component is configured to cause the door interaction component to move and to apply a force on the access door.
